(19) United States
(12) Patent Application Publication
(10) Pub. No.: US 2026/0088550 A1
(43) Pub. Date: Mar. 26, 2026

(54) ELECTRICAL CONNECTOR

(71) Applicant: CHENG UEI PRECISION INDUSTRY CO., LTD., New Taipei City (TW)

(72) Inventors: CHAO YE, Dong-Guan City (CN); JUN CHEN, Dong-Guan City (CN)

(21) Appl. No.: 19/088,949

(22) Filed: Mar. 24, 2025

(30) Foreign Application Priority Data
Sep. 25, 2024 (CN) 202422348379.7

(51) Int. Cl. H01R 13/42; H01R 13/6581

(52) U.S. Cl. CPC H01R 13/42; H01R 13/6581

(57) ABSTRACT

An electrical connector includes a shielding shell, an insulating body fastened in the shielding shell, and a plurality of contacting terminals. The insulating body has two extension parts protruded rearward from two sides of a rear end of the insulating body, and a covering part connected between two tail ends of the two extension parts and extending downward. The plurality of the contacting terminals are arranged in the insulating body. Each extension part has an upper surface and a lower surface which are opposite to each other. The covering part has an inner wall, an outer wall and two opposite side surfaces. An inner side of a rear end of the lower surface of each extension part slantwise extends inward and downward to form the side surface. A chamfer is formed at a junction between the lower surface and the side surface.

### CROSS REFERENCE TO RELATED APPLICATIONS

The present application is based on, and claims priority from, China Patent Application No. 202422348379.7, filed September 25 2024, the disclosure of which is hereby incorporated by reference herein in its entirety.

### BACKGROUND OF THE INVENTION

### Field of the Invention

The present invention generally relates to an electrical connector, and more particularly to an electrical connector having a stable structure and a better air tightness.

### Description of Related Art

Referring to FIG. 13 to FIG. 16, a conventional electrical connector 100′ includes a shielding shell 60′, an insulating body 70′ fixed in the shielding shell 60′, and a plurality of contacting terminals 21′ arranged in the insulating body 70′. A rear end of the insulating body 70′ extends rearward to form a fixing part 15′ for securing the plurality of the contacting terminals 21′. The insulating body 70′, the shielding shell 60′ and the fixing part 15′ together define a holding space S50′. The holding space S50′ is filled with sealing glue 50′ to enhance a waterproof performance and a sealing performance of the electrical connector 100′.

Referring to FIG. 14 and FIG. 16, in order to make the fixing part 15′ matched with a shape of each contacting terminal 21′, the fixing part 15′ is provided with an extension part 11′ extending horizontally, and a covering part 12′ vertically extended downward from the extension part 11′. A lower surface 111′ of the extension part 11′ and an inner edge 61′ of the shielding shell 60′ further define a gap S51′ in the holding space S50′. When a width of the gap S51′ is reduced to a certain threshold, the gap S51′ exerts a siphon effect on the sealing glue 50′ which is adjacent to the gap S51′, so a siphon force is applied on the sealing glue 50′. The narrower the gap S51′ is, the stronger the siphon force applied on the sealing glue 50′ is. The sealing glue 50′ coated to a rear surface 62′ of the shielding shell 60′ is apt to be drawn into the gap S51′, and a seam between the insulating body 70′ and the shielding shell 60′ is unfilled by the sealing glue 50′, so an air tightness performance and a waterproof performance of the electrical connector 100′ is reduced.

Therefore, it is necessary to provide an electrical connector having a better air tightness and a stable structure.

### BRIEF SUMMARY OF THE INVENTION

An object of the present invention is to provide an electrical connector having a stable structure and a better air tightness. The electrical connector includes a shielding shell, an insulating body fastened in the shielding shell, and a plurality of contacting terminals. The insulating body has two extension parts protruded rearward from two sides of a rear end of the insulating body, and a covering part connected between two tail ends of the two extension parts and extending downward. The plurality of the contacting terminals are arranged in the insulating body. Rear ends of the plurality of the contacting terminals extend out of the rear end of the insulating body, and the rear ends of the plurality of the contacting terminals are covered by the covering part. Each extension part has an upper surface and a lower surface which are opposite to each other, and an inner side and an outer side which are opposite to each other, the covering part has an inner wall, an outer wall and two opposite side surfaces, an inner side of a rear end of the lower surface of each extension part slantwise extends inward and downward to form the side surface, a chamfer is formed at a junction between the lower surface and the side surface, two sides of the inner wall of the covering part protrude frontward to form two reinforcing blocks, each reinforcing block has an exterior surface, a front connecting surface, and a bottom connecting surface connected with a bottom end of the front connecting surface, the exterior surface of each reinforcing block is extended frontward from a top of one side surface, the front connecting surface of each reinforcing block is connected between a front end of the exterior surface and a front end of an interior surface of the reinforcing block, the bottom connecting surface of each reinforcing block is connected between a bottom of the exterior surface and a bottom of the interior surface of the reinforcing block, a bottom of the front connecting surface, the bottom connecting surface and a bottom of the exterior surface of each reinforcing block are perpendicular, so a right angle is formed at a front end of a bottom of each reinforcing block, the bottom connecting surface is flush with a lower edge of the inner wall.

Another object of the present invention is to provide an electrical connector. The electrical connector includes a shielding shell, an insulating body fastened in the shielding shell, and a plurality of contacting terminals. The insulating body has two extension parts protruded rearward from two sides of a rear end of the insulating body, and a covering part connected between two tail ends of the two extension parts and extending downward. The plurality of the contacting terminals are arranged in the insulating body. Rear ends of the plurality of the contacting terminals extend out of the rear end of the insulating body, and the rear ends of the plurality of the contacting terminals are covered by the covering part. Each extension part has an upper surface and a lower surface which are opposite to each other, the covering part has an inner wall, an outer wall and two opposite side surfaces, an inner side of a rear end of the lower surface of each extension part slantwise extends inward and downward to form the side surface, a chamfer is formed at a junction between the lower surface and the side surface, two sides of the inner wall of the covering part protrude frontward to form two reinforcing blocks, each reinforcing block has an exterior surface, a front connecting surface, and a bottom connecting surface connected with a bottom end of the front connecting surface, the exterior surface of each reinforcing block is extended frontward from a top of one side surface, the front connecting surface of each reinforcing block is connected between a front end of the exterior surface and a front end of an interior surface of the reinforcing block, a junction between the front connecting surface and the lower surface obliquely extends downward and rearward to form a bevel, the bottom connecting surface of each reinforcing block is connected between a bottom of the exterior surface and a bottom of the interior surface of the reinforcing block, a bottom of the front connecting surface, the bottom connecting surface and a bottom of the exterior surface of each reinforcing block are perpendicular, the bottom connecting surface is flush with a lower edge of the inner wall.

Another object of the present invention is to provide an electrical connector. The electrical connector includes an insulating body, a plurality of contacting terminals and a shielding shell. The insulating body has two extension parts protruded rearward from two sides of a rear end of the insulating body, and a covering part connected between two tail ends of the two extension parts and extending downward. The plurality of the contacting terminals are arranged in the insulating body. Rear ends of the plurality of the contacting terminals extend out of the rear end of the insulating body, and the rear ends of the plurality of the contacting terminals are covered by the covering part. The insulating body is fastened in the shielding shell. Lower surfaces of the two extension parts are spaced from an inner edge of the shielding shell to form a gap between the lower surfaces of the two extension parts and the inner edge of the shielding shell. The gap is filled with sealing glue. The covering part has an inner wall, an outer wall and two opposite side surfaces, an inner side of a rear end of the lower surface of each extension part slantwise extends inward and downward to form the side surface, a chamfer is formed at a junction between the lower surface and the side surface, two sides of the inner wall of the covering part protrude frontward to form two reinforcing blocks, each reinforcing block has an exterior surface, a front connecting surface, and a bottom connecting surface connected with a bottom end of the front connecting surface, the exterior surface of each reinforcing block is extended frontward from a top of one side surface, the front connecting surface of each reinforcing block is connected between a front end of the exterior surface and a front end of an interior surface of the reinforcing block, the bottom connecting surface of each reinforcing block is connected between a bottom of the exterior surface and a bottom of the interior surface of the reinforcing block, a bottom of the front connecting surface, the bottom connecting surface and a bottom of the exterior surface of each reinforcing block are perpendicular, the bottom connecting surface is flush with a lower edge of the inner wall.

As described above, the electrical connector shortens a distance between the upper surface and the lower surface of each extension part, and the chamfer, the bevel and the two reinforcing blocks are disposed between the two extension parts and the covering part, so the electrical connector has a structural reliability. Furthermore, when the electrical connector is under the premise of ensuring the structural reliability, the gap between the lower surfaces of the two extension parts and the inner edge of the shielding shell is enlarged, and a siphon effect and a suction force on the sealing glue by the gap are reduced, so that the sealing glue is distributed more evenly, and the electrical connector achieves a better air tightness for enhancing a waterproof performance of the electrical connector.

Therefore, the electrical connector has advantages of a stable structure and the better air tightness.

### BRIEF DESCRIPTION OF THE DRAWINGS

The present invention will be apparent to those skilled in the art by reading the following description, with reference to the attached drawings, in which:

FIG. 1 is an exploded view of an electrical connector according to the present invention;

FIG. 2 is a perspective view of the electrical connector according to the present invention;

FIG. 3 is an exploded view of a terminal module of the electrical connector according to the present invention;

FIG. 4 is another exploded view of the terminal module of the electrical connector according to the present invention;

FIG. 5 is a perspective view of an insulating body of the electrical connector according to the present invention;

FIG. 6 is a rear view of the electrical connector according to the present invention;

FIG. 7 is a partial cross-sectional view of the electrical connector along a line VII-VII of FIG. 6;

FIG. 8 is a right-side view of the insulating body of the electrical connector according to the present invention;

FIG. 9 is a cross-sectional view of the insulating body of the electrical connector along a line IX-IX of FIG. 8;

FIG. 10 is a partial cross-sectional view of the terminal module of the electrical connector according to the present invention;

FIG. 11 is a perspective view of the terminal module of the electrical connector according to the present invention;

FIG. 12 is a partial enlarged view of an encircled portion XII of the terminal module of the electrical connector of FIG. 11;

FIG. 13 is a rear view of a conventional electrical connector in prior art;

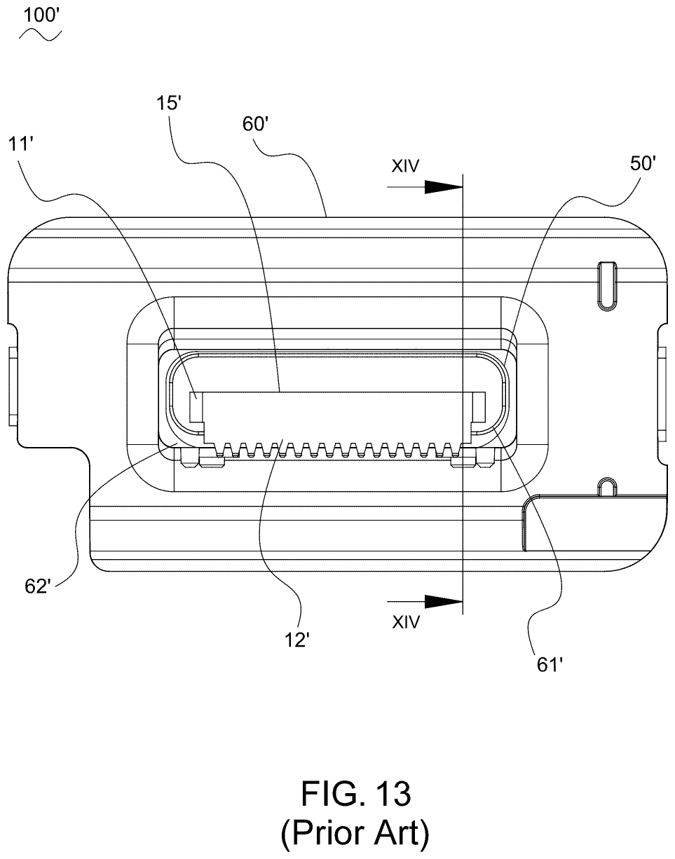

FIG. 14 is a partial cross-sectional view of the conventional electrical connector along a line XIV-XIV of FIG. 13;

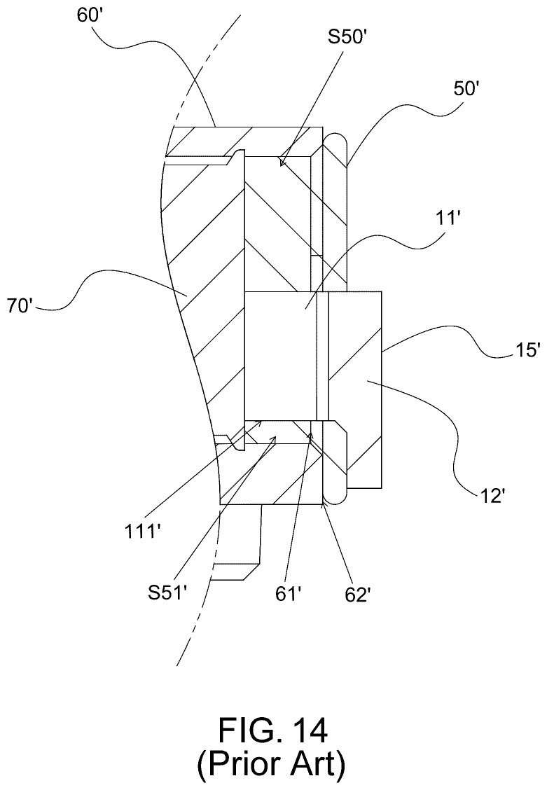

FIG. 15 is a perspective view of an insulating body together with a plurality of contacting terminals of the conventional electrical connector; and

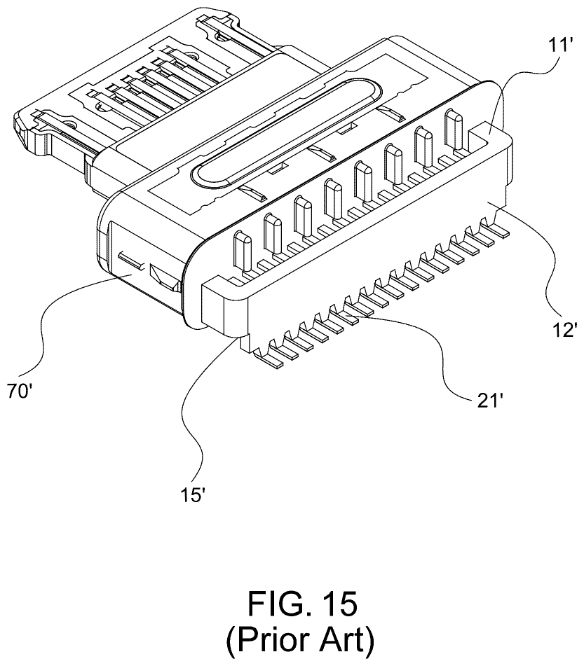

FIG. 16 is a partial cross-sectional view of the insulating body together with the plurality of the contacting terminals of the conventional electrical connector.

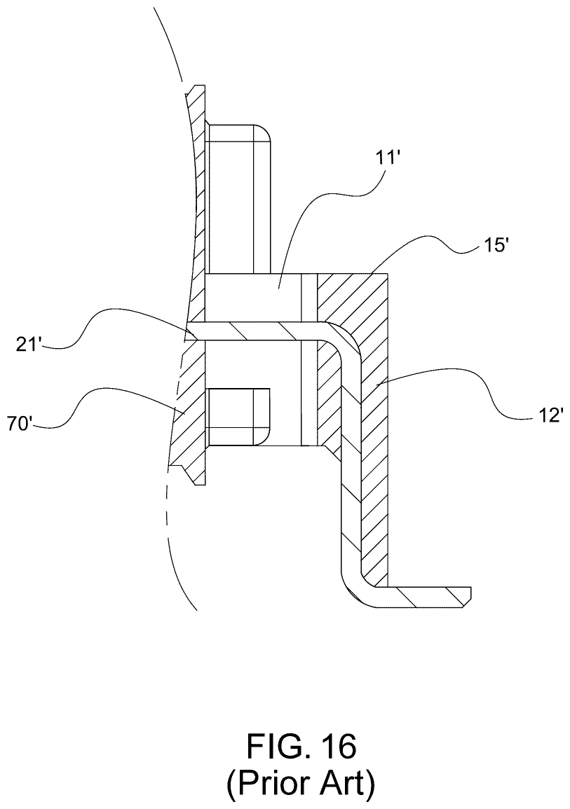

### DETAILED DESCRIPTION OF THE INVENTION

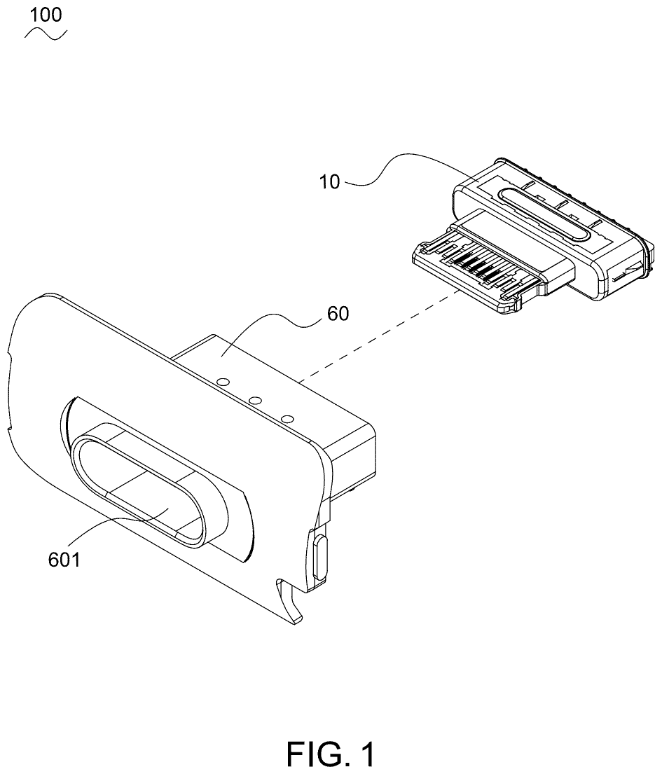

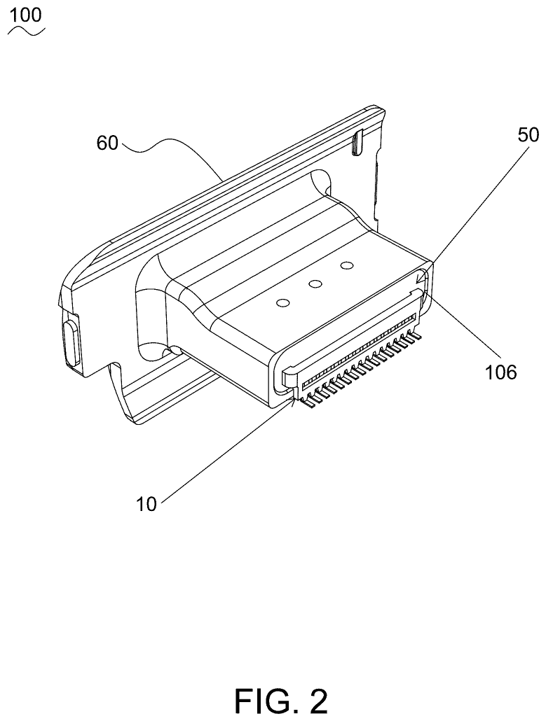

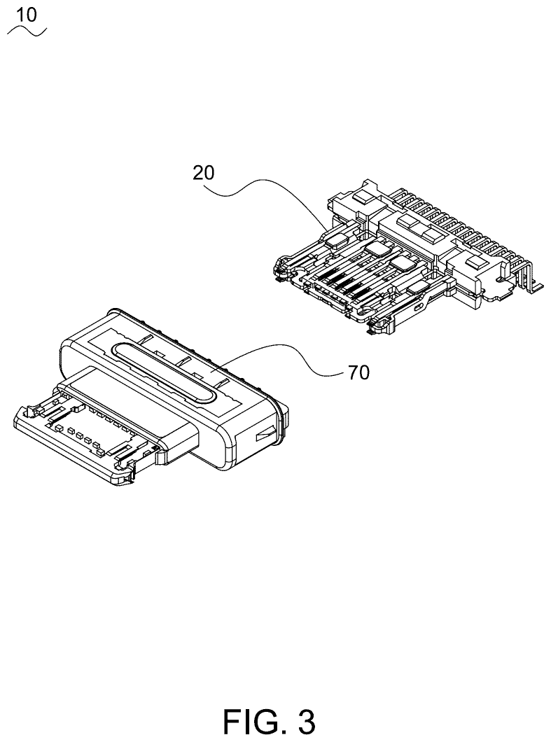

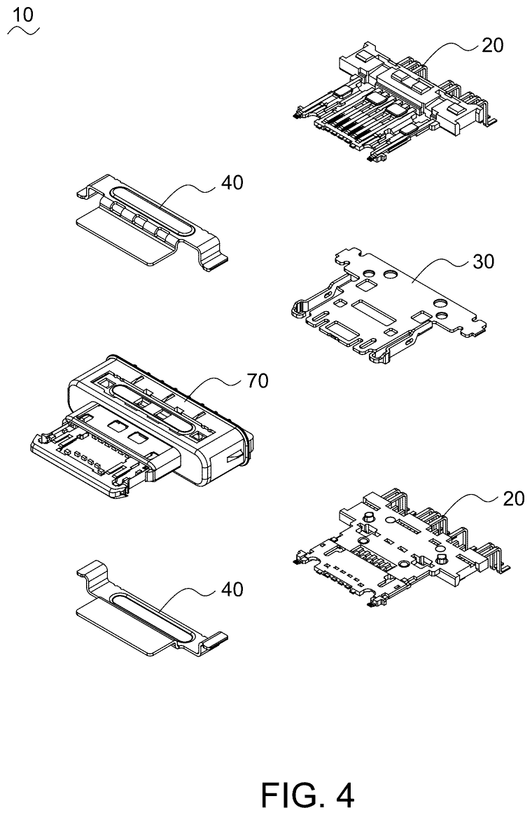

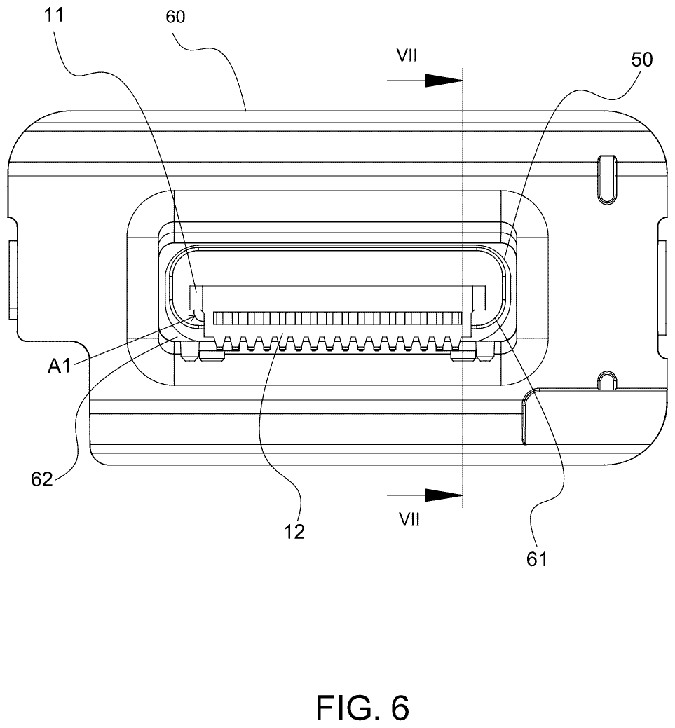

With reference to FIG. 1 to FIG. 12, in order to provide a detailed description of a technical content of an electrical connector 100 in accordance with the present invention, structural features of the electrical connector 100, objectives and effects achieved by the electrical connector 100 according to the present invention, the electrical connector 100 according to following embodiments of the present invention are given in conjunction with drawings for a detailed explanation. The electrical connector 100 in accordance with the embodiment of the present invention is a Type-C connector, in practice, the electrical connector 100 is also able to be other types of connectors.

Referring to FIG. 1 to FIG. 4, the electrical connector 100 includes a shielding shell 60, a terminal module 10 and sealing glue 50. An inside of the shielding shell 60 forms a receiving space 601. The terminal module 10 is accommodated in the receiving space 601. The sealing glue 50 is coated to a rear end of the terminal module 10 to seal up a seam 106 between the terminal module 10 and the shielding shell 60. The terminal module 10 further includes an insulating body 70 which is formed inside a mold, a contacting terminal assembly 20 assembled and combined inside the mold, a central piece 30 arranged in a middle of the contacting terminal assembly 20, and two shielding pieces 40 respectively arranged at an upper portion and a lower portion of a rear end of the insulating body 70.

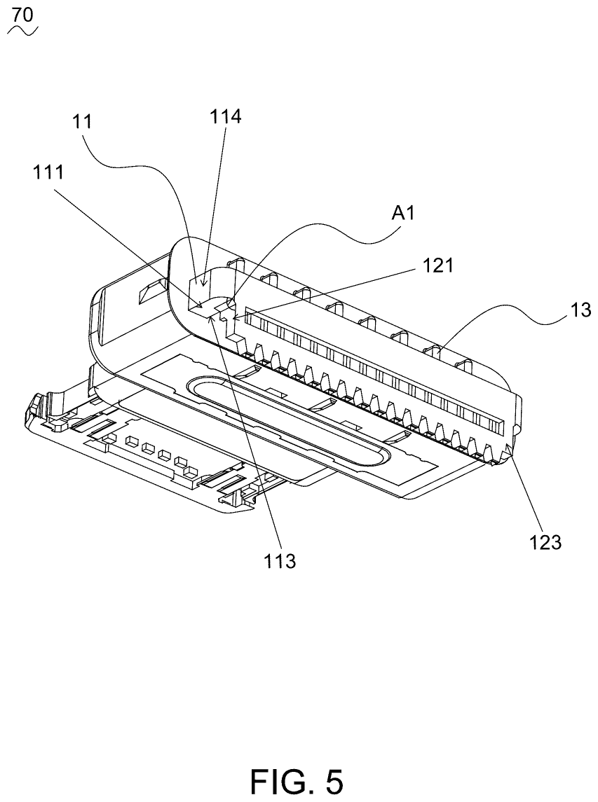

Referring to FIG. 5 to FIG. 7, the insulating body 70 is fastened in the shielding shell 60. The insulating body 70 has two extension parts 11 protruded rearward from two sides of the rear end of the insulating body 70, and a covering part 12 connected between two tail ends of the two extension parts 11 and extending downward. Each extension part 11 has an upper surface 112 and a lower surface 111 which are opposite to each other, and an inner side 113 and an outer side 114 which are opposite to each other. Two free ends of the two extension parts 11 extend towards each other to form the covering part 12 extending downward. The covering part 12 extends beyond the two lower surfaces 111 of the two extension parts 11. The covering part 12, the rear end of the insulating body 70 and the shielding shell 60 together form a holding space S50, and the holding space S50 is coated with the sealing glue 50. A coating range of the sealing glue 50 overflows an inner edge 61 of the shielding shell 60 and covers a rear surface 62 of the shielding shell 60 around the inner edge 61.

Referring to FIG. 5 to FIG. 12, the covering part 12 has an inner wall 122, an outer wall 123 and two opposite side surfaces 121. An inner side of a rear end of the lower surface 111 of each extension part 11 slantwise extends inward and downward to form the side surface 121. A lower end of the side surface 121 extends downward. A chamfer Al is formed at a junction between the lower surface 111 and the side surface 121. The lower surfaces 111 of the two extension parts 11 and the inner edge 61 of the shielding shell 60 further define a gap S51 in the holding space S50. The lower surfaces 111 of the two extension parts 11 are spaced from the inner edge 61 of the shielding shell 60 to form the gap S51 between the lower surfaces 111 of the two extension parts 11 and the inner edge 61 of the shielding shell 60. The gap S51 is filled with sealing glue 50.

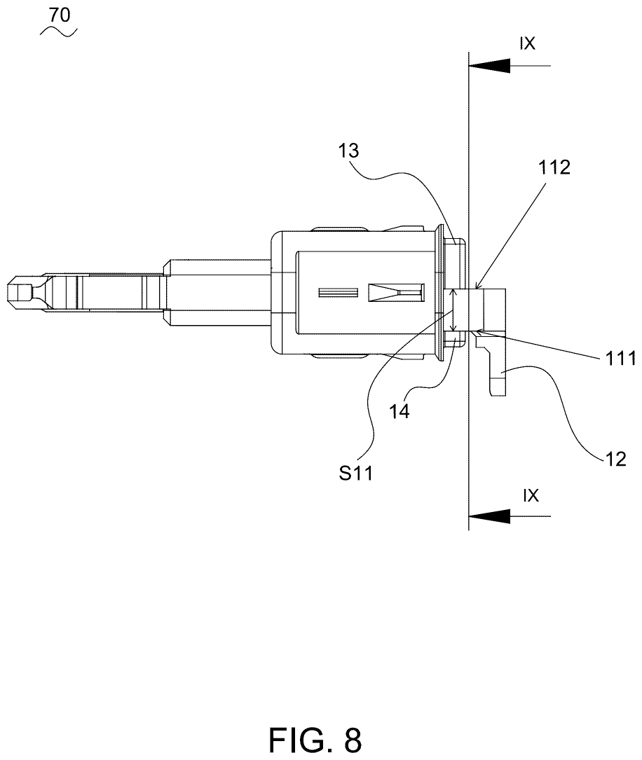

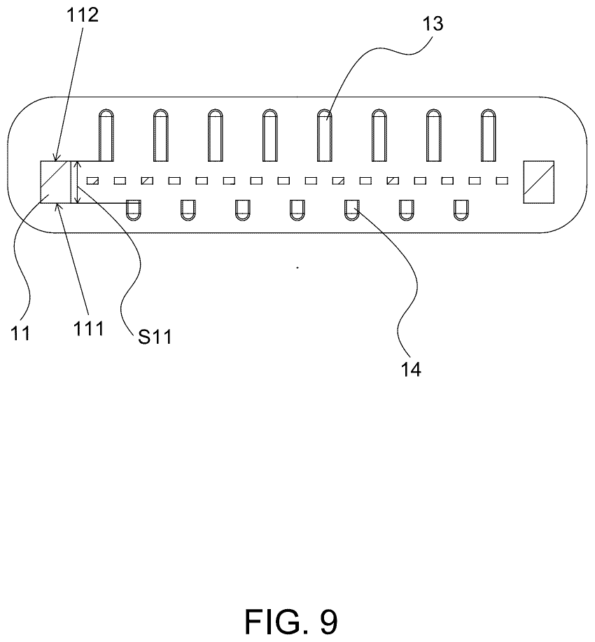

Referring to FIG. 8 and FIG. 9, in this embodiment, the rear end of the insulating body 70 is provided with a plurality of upper protrusions 13 and a plurality of lower protrusions 14 arranged in a stagger manner. The plurality of the upper protrusions 13 and the plurality of the lower protrusions 14 are arranged along an up-down direction to be arranged in two rows. The plurality of the lower protrusions 14 are located under the plurality of the upper protrusions 13. The covering part 12 is located behind the plurality of the upper protrusions 13 and the plurality of the lower protrusions 14. The upper surfaces 112 of the two extension parts 11 are flush with bottom surfaces of the plurality of the upper protrusions 13. The lower surfaces 111 of the two extension parts 11 are lower than upper edges of the plurality of the lower protrusions 14, and lower edges of the plurality of the lower protrusions 14 are lower than the lower surfaces 111 of the two extension parts 11. A distance S11 between the upper surface 112 and the lower surface 111 of each extension part 11 in the present invention is shortened, a width of the gap S51 is increased, a siphon effect which is exerted on the sealing glue 50 by the gap S51 is weakened, so that the sealing glue 50 is prevented from being drawn into the gap S51.

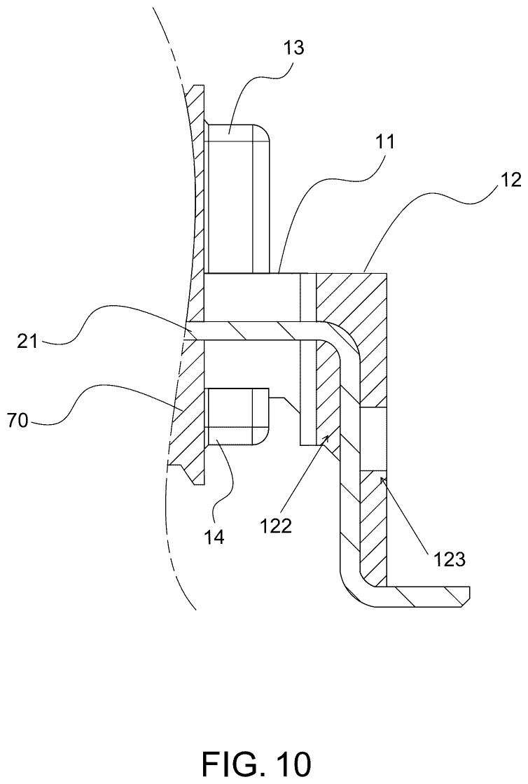

Referring to FIG. 10, the contacting terminal assembly 20 includes a plurality of contacting terminals 21 arranged in the insulating body 70. Front ends of the plurality of the contacting terminals 21 are fixed in the insulating body 70. Rear ends of the plurality of the contacting terminals 21 extend out of the rear end of the insulating body 70, and the rear ends of the plurality of the contacting terminals 21 are covered by the covering part 12. A front and a rear of the covering part 12 have the inner wall 122 and the outer wall 123 opposite to each other. The inner wall 122 of the covering part 12 is located in front of the outer wall 123 of the covering part 12. An inner surface of each extension part 11 extends vertically to form the inner wall 122. An outer surface of each extension part 11 extends vertically to form the outer wall 123. The rear ends of the plurality of the contacting terminals 21 extend between the inner wall 122 and the outer wall 123 of the covering part 12.

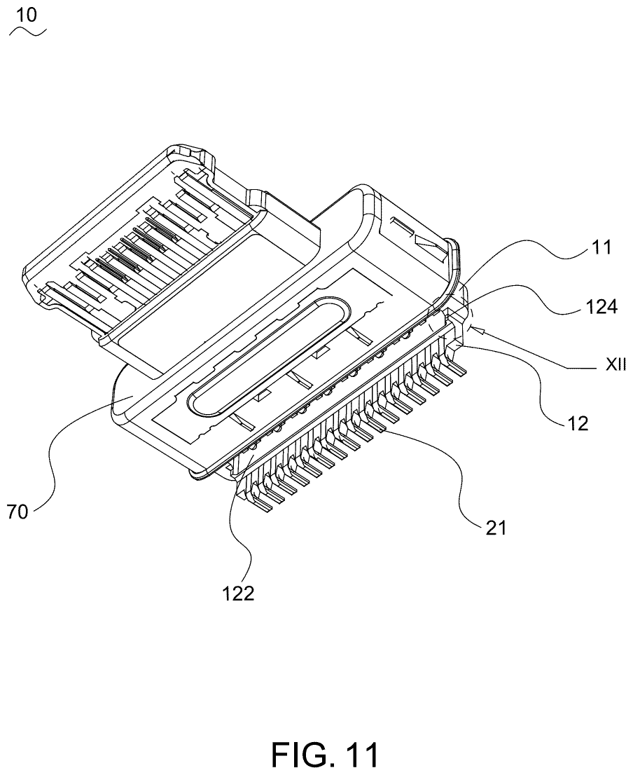

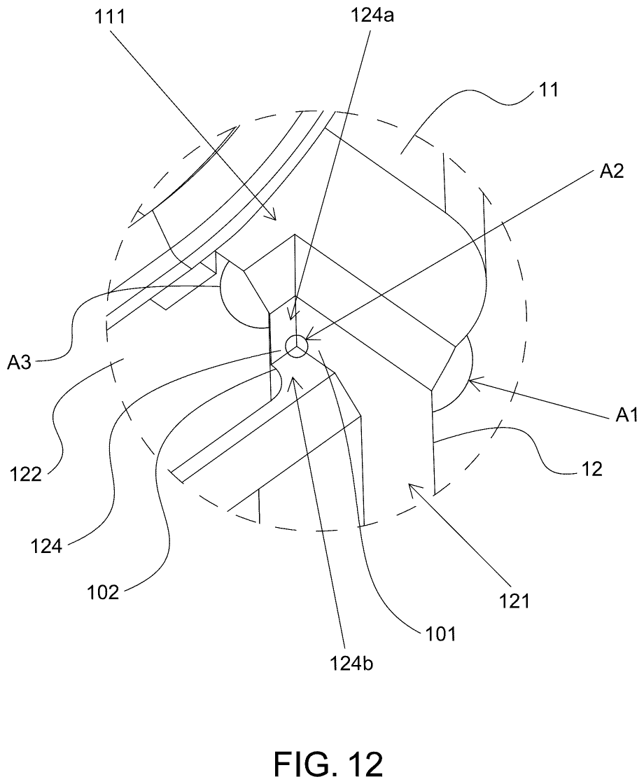

With reference to FIG. 11 and FIG. 12, in this embodiment, two sides of the inner wall 122 of the covering part 12 protrude frontward to form two reinforcing blocks 124. A forward extending length of each reinforcing block 124 is less than half of a rearward extending length of each extension part 11.

Each reinforcing block 124 has an exterior surface 101, a front connecting surface 124a, and a bottom connecting surface 124b connected with a bottom end of the front connecting surface 124a. The exterior surface 101 of each reinforcing block 124 is extended frontward from a top of one side surface 121. The front connecting surface 124a, a front end of the exterior surface 101 and a front end of an interior surface 102 of each reinforcing block 124 are connected. The front connecting surface 124a of each reinforcing block 124 is connected between the front end of the exterior surface 101 and the front end of the interior surface 102 of the reinforcing block 124. The bottom connecting surface 124b, a bottom of the exterior surface 101 and a bottom of the interior surface 102 of each reinforcing block 124 are connected. The bottom connecting surface 124b of each reinforcing block 124 is connected between the bottom of the exterior surface 101 and the bottom of the interior surface 102 of the reinforcing block 124.

A bottom of the front connecting surface 124a, the bottom connecting surface 124b and a bottom of the exterior surface 101 of each reinforcing block 124 are perpendicular, so a right angle A2 is formed at a front end of a bottom of each reinforcing block 124. The rear end of the lower surface 111 of each extension part 11 slantwise extends downward and rearward, and then extends downward to form the front connecting surface 124a. A junction between the front connecting surface 124a and the lower surface 111 obliquely extends downward and rearward to form a bevel A3. The bottom connecting surface 124b is flush with a lower edge of the inner wall 122.

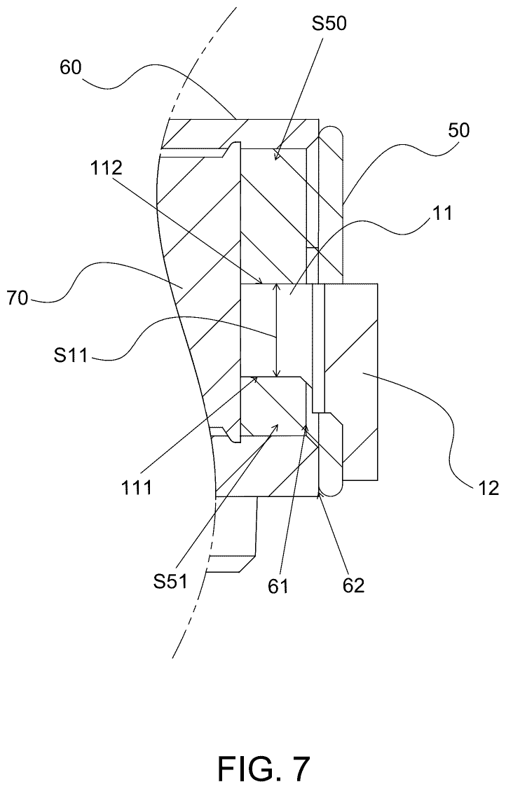

Referring to FIG. 7 to FIG. 12, in order to avoid distributing the sealing glue 50 unevenly by the siphon effect, the distance S11 between the upper surface 112 and the lower surface 111 of each extension part 11 is shortened, and the chamfer Al is provided to enlarge the gap S51. At the same time, the bevel A3 is provided between the front connecting surface 124a and the lower surface 111, and the two reinforcing blocks 124 are provided at a front end of the inner wall 122 of the covering part 12 to ensure a structural stability of the two extension parts 11. The siphon effect on the sealing glue 50 is weakened by enlarging the width of the gap S51, so that an uneven distribution of the sealing glue 50 and a cracking problem of the sealing glue 50 are prevented, ultimately, the holding space S50 between the rear end of the insulating body 70 and the shielding shell 60 is sealed reliably, an air tightness of the electrical connector 100 is improved.

As described above, the electrical connector 100 shortens the distance S11 between the upper surface 112 and the lower surface 111 of each extension part 11, and the chamfer A1, the bevel A3 and the two reinforcing blocks 124 are disposed between the two extension parts 11 and the covering part 12, so the electrical connector 100 has a structural reliability. Furthermore, when the electrical connector 100 is under the premise of ensuring the structural reliability, the gap S51 between the lower surfaces 111 of the two extension parts 11 and the inner edge 61 of the shielding shell 60 is enlarged, and the siphon effect and the suction force on the sealing glue 50 by the gap S51 are reduced, so that the sealing glue 50 is distributed more evenly, and the electrical connector 100 achieves a better air tightness for enhancing a waterproof performance of the electrical connector 100. Therefore, the electrical connector 100 has advantages of a stable structure and the better air tightness.

Though the present invention is disclosed as the above-mentioned embodiment, the embodiment disclosed in this invention is without being intended to limit a scope of this invention. In related technical fields, anyone with ordinary knowledges should be able to make a few changes and embellishments within a spirit and a protection scope of this invention, so the protection scope of this invention should regard defined claims of an attached application patent as a standard.

What is claimed is:

1. An electrical connector, comprising:
a shielding shell;
an insulating body fastened in the shielding shell, the insulating body having two extension parts protruded rearward from two sides of a rear end of the insulating body, and a covering part connected between two tail ends of the two extension parts and extending downward; and
a plurality of contacting terminals arranged in the insulating body, rear ends of the plurality of the contacting terminals extending out of the rear end of the insulating body, and the rear ends of the plurality of the contacting terminals being covered by the covering part;
wherein each extension part has an upper surface and a lower surface which are opposite to each other, and an inner side and an outer side which are opposite to each other, the covering part has an inner wall, an outer wall and two opposite side surfaces, an inner side of a rear end of the lower surface of each extension part slantwise extends inward and downward to form the side surface, a chamfer is formed at a junction between the lower surface and the side surface, two sides of the inner wall of the covering part protrude frontward to form two reinforcing blocks, each reinforcing block has an exterior surface, a front connecting surface, and a bottom connecting surface connected with a bottom end of the front connecting surface, the exterior surface of each reinforcing block is extended frontward from a top of one side surface, the front connecting surface of each reinforcing block is connected between a front end of the exterior surface and a front end of an interior surface of the reinforcing block, the bottom connecting surface of each reinforcing block is connected between a bottom of the exterior surface and a bottom of the interior surface of the reinforcing block, a bottom of the front connecting surface, the bottom connecting surface and a bottom of the exterior surface of each reinforcing block are perpendicular, so a right angle is formed at a front end of a bottom of each reinforcing block, the bottom connecting surface is flush with a lower edge of the inner wall.

2. The electrical connector as claimed in claim 1, wherein the rear end of the lower surface of each extension part slantwise extends downward and rearward, and then extends downward to form the front connecting surface, a junction between the front connecting surface and the lower surface obliquely extends downward and rearward to form a bevel.

3. The electrical connector as claimed in claim 1, wherein a forward extending length of each reinforcing block is less than half of a rearward extending length of each extension part.

4. The electrical connector as claimed in claim 1, wherein the rear end of the insulating body is provided with a plurality of upper protrusions and a plurality of lower protrusions arranged in a stagger manner, the plurality of the upper protrusions and the plurality of the lower protrusions are arranged along an up-down direction to be arranged in two rows, the plurality of the lower protrusions are located under the plurality of the upper protrusions, the upper surfaces of the two extension parts are flush with bottom surfaces of the plurality of the upper protrusions, lower edges of the plurality of the lower protrusions are lower than the lower surfaces of the two extension parts.

5. The electrical connector as claimed in claim 4, wherein the lower surfaces of the two extension parts are lower than upper edges of the plurality of the lower protrusions.

6. The electrical connector as claimed in claim wherein the covering part is located behind the plurality of the upper protrusions and the plurality of the lower protrusions.

7. The electrical connector as claimed in claim 1, wherein the covering part, the rear end of the insulating body and the shielding shell together form a holding space, and the holding space is coated with sealing glue.

8. The electrical connector as claimed in claim 7, wherein the lower surfaces of the two extension parts and an inner edge of the shielding shell further define a gap in the holding space.

9. The electrical connector as claimed in claim 1, wherein the inner wall of the covering part is located in front of the outer wall of the covering part, an inner surface of each extension part extends vertically to form the inner wall, an outer surface of each extension part extends vertically to form the outer wall, the rear ends of the plurality of the contacting terminals extend between the inner wall and the outer wall of the covering part.

10. An electrical connector, comprising:
a shielding shell;
an insulating body fastened in the shielding shell, the insulating body having two extension parts protruded rearward from two sides of a rear end of the insulating body, and a covering part connected between two tail ends of the two extension parts and extending downward; and
a plurality of contacting terminals arranged in the insulating body, rear ends of the plurality of the contacting terminals extending out of the rear end of the insulating body, and the rear ends of the plurality of the contacting terminals being covered by the covering part;
wherein each extension part has an upper surface and a lower surface which are opposite to each other, the covering part has an inner wall, an outer wall and two opposite side surfaces, an inner side of a rear end of the lower surface of each extension part slantwise extends inward and downward to form the side surface, a chamfer is formed at a junction between the lower surface and the side surface, two sides of the inner wall of the covering part protrude frontward to form two reinforcing blocks, each reinforcing block has an exterior surface, a front connecting surface, and a bottom connecting surface connected with a bottom end of the front connecting surface, the exterior surface of each reinforcing block is extended frontward from a top of one side surface, the front connecting surface of each reinforcing block is connected between a front end of the exterior surface and a front end of an interior surface of the reinforcing block, a junction between the front connecting surface and the lower surface obliquely extends downward and rearward to form a bevel, the bottom connecting surface of each reinforcing block is connected between a bottom of the exterior surface and a bottom of the interior surface of the reinforcing block, a bottom of the front connecting surface, the bottom connecting surface and a bottom of the exterior surface of each reinforcing block are perpendicular, the bottom connecting surface is flush with a lower edge of the inner wall.

11. An electrical connector, comprising:
an insulating body having two extension parts protruded rearward from two sides of a rear end of the insulating body, and a covering part connected between two tail ends of the two extension parts and extending downward;
a plurality of contacting terminals arranged in the insulating body, rear ends of the plurality of the contacting terminals extending out of the rear end of the insulating body, and the rear ends of the plurality of the contacting terminals being covered by the covering part; and
a shielding shell, the insulating body being fastened in the shielding shell, lower surfaces of the two extension parts being spaced from an inner edge of the shielding shell to form a gap between the lower surfaces of the two extension parts and the inner edge of the shielding shell, the gap being filled with sealing glue;
wherein the covering part has an inner wall, an outer wall and two opposite side surfaces, an inner side of a rear end of the lower surface of each extension part slantwise extends inward and downward to form the side surface, a chamfer is formed at a junction between the lower surface and the side surface, two sides of the inner wall of the covering part protrude frontward to form two reinforcing blocks, each reinforcing block has an exterior surface, a front connecting surface, and a bottom connecting surface connected with a bottom end of the front connecting surface, the exterior surface of each reinforcing block is extended frontward from a top of one side surface, the front connecting surface of each reinforcing block is connected between a front end of the exterior surface and a front end of an interior surface of the reinforcing block, the bottom connecting surface of each reinforcing block is connected between a bottom of the exterior surface and a bottom of the interior surface of the reinforcing block, a bottom of the front connecting surface, the bottom connecting surface and a bottom of the exterior surface of each reinforcing block are perpendicular, the bottom connecting surface is flush with a lower edge of the inner wall.
